(19) United States
(12) Patent Application Publication
(10) Pub. No.: US 2003/0046254 A1
(43) Pub. Date: Mar. 6, 2003

(54) Apparatus for controlling electrical device using bio-signal and method thereof

(76) Inventors: Chang Su Ryu, Daejon-shi (KR); Yoon Seon Song, Daejon-shi (KR); Min Joon Kim, Daejon-shi (KR); Seung Chul Shin, Daejon-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/085,665

(22) Filed: Feb. 26, 2002

(30) Foreign Application Priority Data
Feb. 27, 2001 (KR) 2001-10023

(51) Int. Cl. G06N 3/06

(52) U.S. Cl. 706/15

(57) ABSTRACT

The present invention relates to an apparatus for controlling an electrical device using a bio-signal measured when a user moves his/her face, and method thereof. The apparatus according to the present invention comprises a bio-signal detection unit for detecting the bio-signal generated when the user firmly shuts his/her mouth and when the user moves his/her head; a bio-signal amplification unit for amplifying the amount of the bio-signal detected in the bio-signal detection unit; an A/D converter for converting the amplified bio-signal into the bio-signal of a digital mode; a control unit for analyzing the bio-signal of the digital mode to determine a corresponding command of the user and then generating a determined command of the user; and a transmission unit for transmitting the determined command to the electrical device via infrared rays. Therefore, the present invention can be used to input various commands more realistically in a virtual reality since the hands and a foot can be used for another work.

### BACKGROUND OF THE INVENTION

1. Field of the Invention

The invention relates generally to an apparatus for controlling an electrical device using a bio-signal that is extracted from movement of a face, and method thereof, and more particularly, to an apparatus for controlling an electrical device using a bio-signal capable of controlling an electrical device only by simply moving a face portion, and method thereof.

2. Description of the Prior Art

In case of a computer, a user interface has been changed from a command-keyboard mode to an icon-mouse mode. Researches and developments for utilizing voice recognition as the user interface have recently been made. Further, there has been an attempt to research a human-friendly interface using a face expression, a gesture, and a bio-signal such as the brain wave(electroencephalogram), the electroocculogram, and the electromyogram.

In case of the brain waves, the brain waves are used in learning or mediation by applying a bio-feedback mode to an alpha wave generated at a relaxed state. Further, there has been developed to control an electrical device using the electroocculogram and blinking which are generated when the pupil of the eye is moved.

A prior art in which the machine is controlled by using the bio-signal measured at the face portion mainly discloses a technology by which the one's eyes are traced through the electroocculogram. The technology has usually employed a method of determining a mental decision (i.e., select a specific icon) by staying one's eyes at the specific icon or blinking one's eyes for a given period of time. However, as the method of tracking one's eyes based on the electroocculogram must correct variations in the location and angle of the face, it is required that the method employ a sensor such as an acceleration sensor or use a camera to perceive variations in the location and angle of the face. In addition, in case of the eye's blinking or staying of one's eyes used to determine a mental decision, additional bio-signals such as brain waves or evoked potentials, or variations in the pupil size were additionally used in order to discriminate between natal and intentional blinking or staying one's eyes. However, the above prior arts have disadvantages that they require a user to hold inconvenient bio-signal detector (for example, a helmet-type device), to prevent a movement of the face during tracking user's eyes, or to fix eye gaze or to blink carefully for the purpose of estimating a mental decision.

These kinds of the prior arts include U.S. Pat. No. 5,649,061 issued to C. C. Smyth (1997), entitled “Device & Method for Estimating a Mental Decision). The patent is to confirm a mental decision of a user by using eye tracking and the evoked potential. Thus, there is a characteristic that the machine can be manipulated only using a user' eyes. However, this method has a disadvantage that it requires a user to hold an inconvenient bio-signal detection unit in order to measure various kinds of bio-signals for estimating a mental decision.

Another prior art includes Korean Patent No. 179250 (issue date: Dec. 26, 1998) issued to LG Co., Ltd., entitled “Input Device Using Motion of an Eyelid”. This prior art uses motion of the eyelid to turn on/off an electrical device. The above patent has an advantage that it can turn on/off consumer electronic devices such as TV, computers, electrical lights, and the like. However, the prior art has a disadvantage that it requires a user to blink intentionally and carefully in order to make a decision and thus makes the user inconvenient.

Still another prior art includes Korean Patent Application No. 1999-0010547 (application date: Mar. 26, 1999) Dail Information Communication Co. entitled “Remote Control Apparatus in an Electrical Device using Motion of the Eyes”. This prior art has electrodes attached on the glasses to track one's eyes through the electroocculogram generated by the motion of the eyes. Thus, a handicapped person can make a selection corresponding to a movement of the mouse and a click by simply moving his/her eyes. However, this patent has also a disadvantage that requires a user to blink and move his/her eyes intentionally and carefully in order to make decision and thus makes the user inconvenient.

### SUMMARY OF THE INVENTION

The present invention is contrived to solve the above problems and an object of the present invention is to provide an apparatus for controlling an electrical device using a bio-signal and method thereof. The invention is capable of controlling equipments more reliably and controlling electrical devices only using a non-expensive and simple apparatus even when the physiological state of a user is varied, in such a way that the apparatus for controlling the electrical device is controlled using the bio-signal extracted from simple motion of a face portion (motion of the head and mouth).

In order to accomplish the above object, an apparatus for controlling an electrical device using a bio-signal detected when a user moves his/her face according to the present invention, is characterized in that it comprises a bio-signal detection means for detecting the bio-signal generated when the user shuts his/her mouth (for example, clench teeth with the mouth shut) and when the user moves his/her head left and right; and a means for controlling the electrical device for analyzing the bio-signal detected in the bio-signal detection means to control the electrical device depending on a command from the user.

Preferably, an apparatus for controlling an electrical device using a bio-signal detected when a user moves his/her face, is characterized in that it comprises a bio-signal detection unit for detecting the bio-signal generated when the user shuts his/her mouth and when the user moves his/her head left and right; a bio-signal amplification unit for amplifying the amount of the bio-signal detected in the bio-signal detection unit; an A/D converter for converting the amplified bio-signal into a digital mode; a control unit for analyzing the bio-signal of the digital mode to determine a corresponding command of the user and then generating a determined command of the user; and a transmission unit for transmitting the command throughout infrared signal from the control unit to the electrical device

More preferably, a method of controlling an electrical device using a bio-signal extracted through movement of a user's face, is characterized in that it comprises the steps of a first step of detecting the bio-signal when the user moves his/her mouth and when the user moves his/her the head; a second step of amplifying the amount of the detected bio-signal and then converting the amplified bio-signal into the bio-signal of a digital mode; a third step of analyzing the converted bio-signal to determine a corresponding command of the user and then generating a determined command; and a fourth step of transmitting the generated command to the electrical device throughout infrared signal.

### BRIEF DESCRIPTION OF THE DRAWINGS

The aforementioned aspects and other features of the present invention will be explained in the following description, taken in conjunction with the accompanying drawings, wherein:

FIG. 1 illustrates an operation flow of an apparatus for controlling an electrical device using a bio-signal according to one embodiment of the present invention;

FIG. 2 is a flowchart illustrates a process of activating a control mode in a control unit used in an apparatus for controlling an electrical device according to the present invention;

FIG. 3 is a flowchart illustrating a process of determining an intention of left/right movement and an intention of selection according to the present invention;

FIG. 4a to FIG. 4c illustrate a method of extracting features from a bio-signal for activating a control mode according to the present invention;

FIG. 5a and FIG. 5b illustrate a method of extracting features from a bio-signal for estimating an intention of left and right movement between command items according to the present invention; and

FIG. 6a and FIG. 6b are drawings for explaining “International 10-20 System of Electrode Placement” used in the present invention.

### DETAILED DESCRIPTION OF PREFERRED EMBODIMENTS

The present invention will be described in detail by way of a preferred embodiment with reference to accompanying drawings.

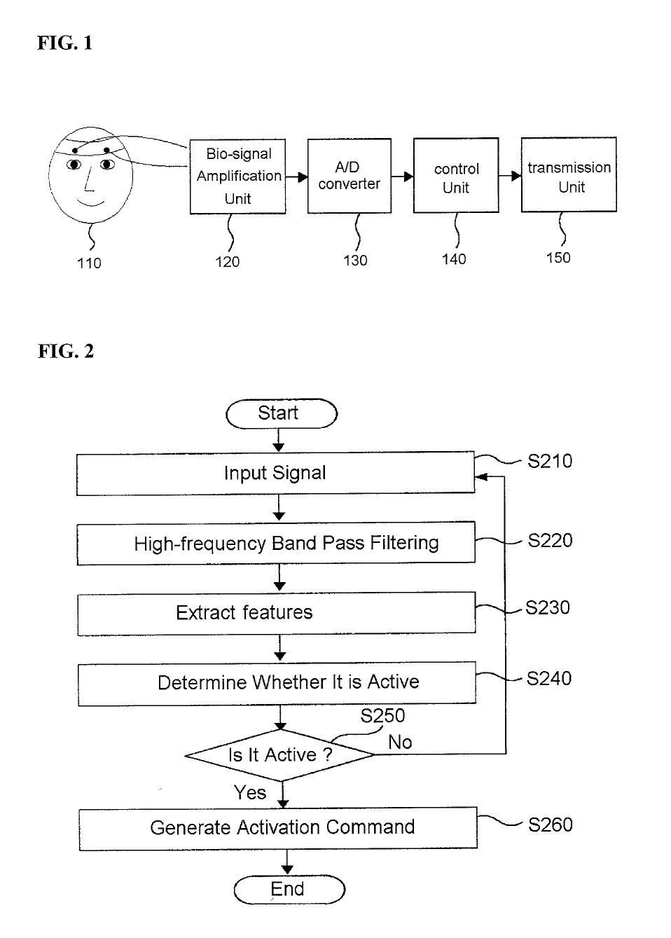

FIG. 1 illustrates an operation flow of an apparatus for controlling an electrical device using a bio-signal according to one embodiment of the present invention.

As shown in FIG. 1, the apparatus for controlling the electrical device includes a bio-signal detection unit 110, a bio-signal amplification unit 120, an A/D converter 130, a control unit 140 and a transmission unit 150.

The bio-signal detection unit 110 detects the bio-signal of a user using two electrodes attached on the forehead of the user. The displacement of the electrodes attached on the forehead follows Fp1 and Fp2 under “International 10-20 System of Electrode Placement”. However, a ground electrode may be positioned between the two electrodes for ground. At this time, as the shape where the ground is positioned does not significantly affects the present invention, the bio-signal detection unit 110 having only two electrodes can be included.

The bio-signal amplification unit 120 amplifies the bio-signal extracted from the bio-signal detection unit 110. At this time, the bio-signal amplification unit 120 does not filter 60 Hz alternating current that is usually performed to measure the bio-signal.

The A/D converter 130 converts the amplified bio-signal of an analog mode into the bio-signal of a digital mode.

The control unit 140 receives the bio signals of the digital mode from the A/D converter 130. Thereafter, The control unit 140 determines an activation/inactivation state of a control mode in a corresponding electrical device, left and right movement, and selection between command items using the bio-signal of the digital mode and then generates a command.

The transmission unit 150 receives a corresponding command from the control unit 140 and then transmits the command to a corresponding electrical device throughout infrared signal.

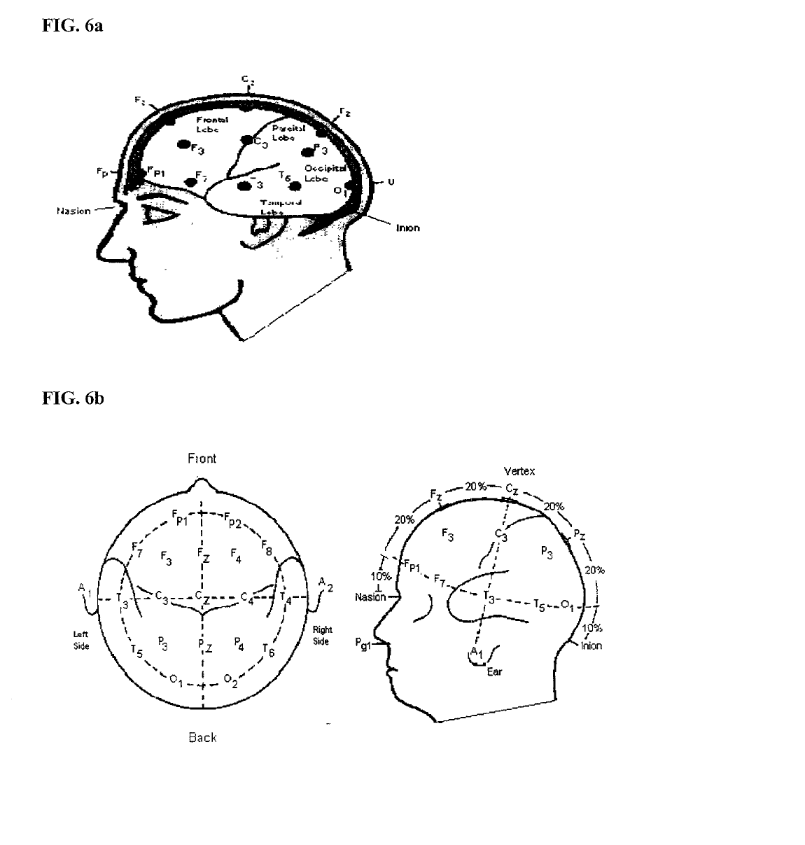

“International 10-20 System of Electrode Placement” used in the present invention is used to explain the location of the electrodes attached on the surface of the head. The method is most widely used, by which the location of the electrodes attached on the surface of the head using characters in which English characters and numbers are combined as shown in FIGS. 6a and 6b is confirmed. At this time, the used characters includes “F”—frontal lobe, “T”—temporal lobe, “C”—middle cranial lobe, “P”—parietal lobe, “O”—occipital lobe, and the like (Note: there is no middle cranial lobe in the cerebral cortex. “C” is only used as confirmation). Even numbers (2, 4, 6, 8) indicate right-side cerebral hemisphere. Odd numbers (1, 3, 5, 7) indicate the locations of the electrodes attached to the right-side cerebral hemisphere.

An operation of the apparatus for controlling the control device as constructed above will be described below.

The bio-signal detection unit 110 detects the bio-signal using the two electrodes attached on the forehead of the user. The bio-signal detection unit 110 then transmits the signal to the bio-signal amplification unit 120. Next, the bio-signal amplification unit 120 amplifies the signal and then transmits the amplified signal to the A/D converter 130. Then, the A/D converter 130 converts the bio-signal of an analog mode into the bio-signal of a digital mode and then transmits the bio-signal of the digital mode to the control unit 140. Next, the control unit 140 determines an activation/inactivation state of a control mode in the electrical device, left and right movement, and selection between command items using the received bio-signal of the digital mode and then generates a command. Thereafter, the transmission unit 150 receives the generated command and then transmits the command to a corresponding electrical device throughout infrared signal.

FIG. 2 is a flowchart illustrates a process of activating the control mode in a corresponding electrical device, using the control unit used in the present invention.

First, the control unit receives a corresponding bio-signal of a digital mode from the A/D converter (S210) and then filter the bio-signal except for electromyogram by using a high-frequency band pass filter of 60˜100 Hz (S220). Features are then extracted from the signal through the high-frequency band pass filter (S230) to determine whether a user want to activate the control mode (S240).

At this time, in the apparatus for controlling the control device according to the present invention, if the user shuts his/her mouth twice sequentially (in detail, firmly clenching teeth with the mouth shut), it means that the control mode of the corresponding electrical device is changed to an active (ON) mode.

Thereafter, it is analyzed that the user changed the corresponding electrical device to the active mode. As a result of the analysis, if it is a command to change the device to the active mode, a corresponding ‘active’ command is transmitted to the transmission unit (S260). On the contrary, if it is not the ‘active’ command of the user, the bio-signal is sequentially received and the above procedure is thus repeated.

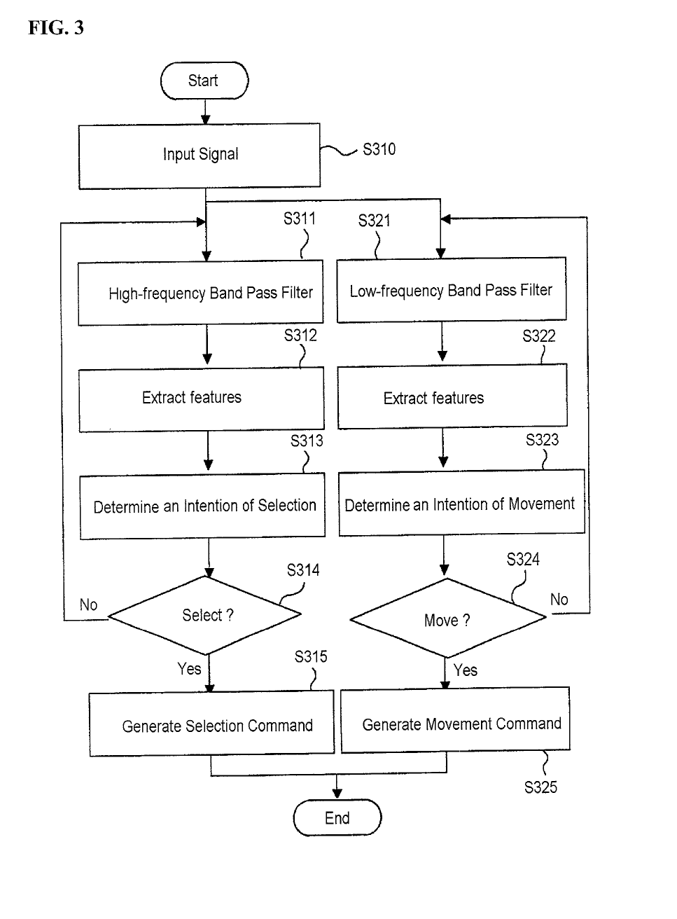

FIG. 3 is a flowchart illustrating a process of determining an intention of left/right movement and an intention of selection between command items through movement of a user's face (firmly shutting mouth and head movement) when the control mode of a corresponding electrical device is activated.

In the apparatus for controlling the control device according to the present invention, it is determined that left (right) movement is made between command items if the user moves his/her head left (right) and a corresponding command item is selected if the user shuts his/her mouth once.

If the bio-signal is received from the A/D converter (S310), the control unit filters the bio-signal except for electromyogram using high-frequency bandpass filter (S311). Then, the control unit extracts features from the filtered bio-signal (S312) to determine whether the user has an intention to select a command among the command items (S313). Next, it is determined that the user has an intention to select the command item (S314). As a result of the determination, if so, the control unit issues a selection command (S315). On the contrary, if not, the control unit sequentially receives the bio-signal and thus repeats the above procedure.

On the other hand, the bio-signal inputted from the A/D converter is passed through the low-frequency band pass filer of 0.1˜5 Hz (S321). Next, corresponding features are extracted from the filtered bio-signal (S322). Then, it is determined that the extracted features indicate an intension of left and right movement (S323). Thereafter, it is determined that the movement is made (S324). As a result of the determination, if a corresponding user has an intention to move left and right between command items, the movement command is generated (S325). On the contrary, if not, the bio-signal is sequentially received and the above procedure is thus repeated.

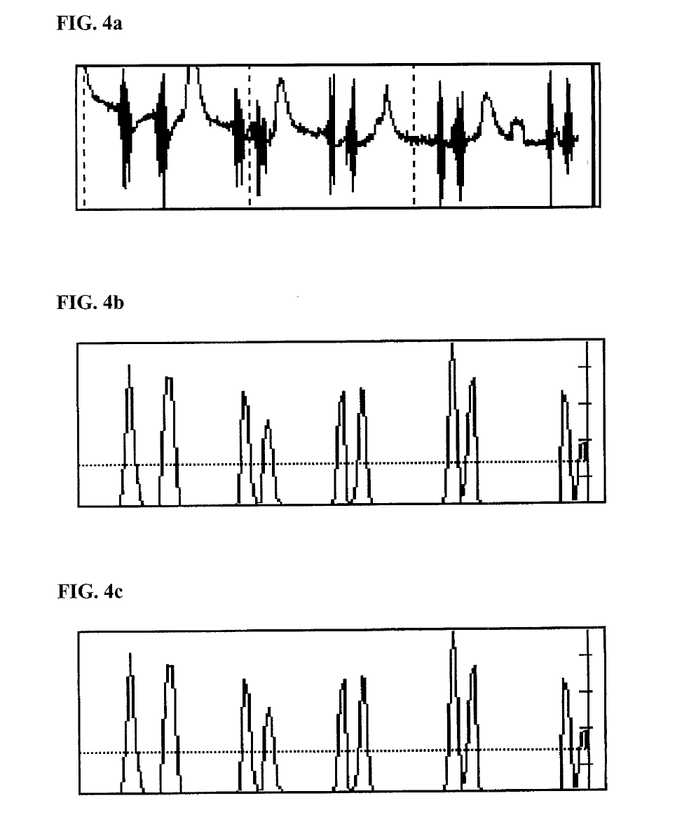

FIG. 4a to FIG. 4c illustrate a method of extracting features used in the apparatus for controlling the control device according to the present invention.

FIG. 4a is a bio-signal diagram inputted from the A/D converter. As shown, the electrodes around the forehead measure electromyogram in every two sequential wave-packets generated when the user sequentially shuts the mouth twice.

FIG. 4b is a signal shape after the high-frequency bandpass filtering. FIG. 4c illustrates an average value of corresponding signal values within a moving time-window for the signal in FIG. 4b. As shown in FIG. 4c, it is determined that the user sequentially shuts the mouth, by examining the presence of two wave-packets at a proper reference value (value indicated by dot line in the drawing), the interval between the two wave-packets, and the presence of other wave-packets on the front and rear of the two wave-packets.

At this time, the time and strength with which the user shuts the mouth may be different. Thus, an initialization step of setting the reference value and the length of the wave-packet suitable for the user may be added. This method can be applied to a method of extracting other features which can be easily used by those having ordinary skill in the art.

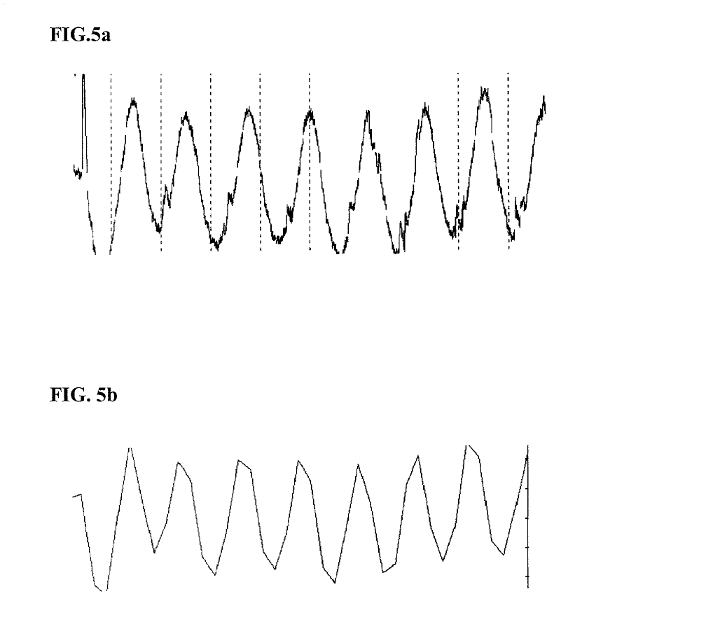

FIG. 5a and FIG. 5b illustrate a method of extracting features necessary in a signal processing process for left and right movement between corresponding command items used in the present invention.

FIG. 5a illustrates the bio-signal measured when the user moves his/her head right and left with his/her eyes fixed to the center of the screen (monitor, TV, etc.). FIG. 5b illustrates a resulting signal after the bio-signal in FIG. 5a is passed through the low-frequency bandpass filter. At this time, right and left movement can be determined by the increase and decrease of the average value of the resulting signal for a given period of time.

Further, at this time, the moving speed and angle of the head may be different, depending on users when using the apparatus for controlling the control device. Thus, an initialization step for obtaining a proper time period suitable for the user and the average value of increase and decrease for a corresponding signal can be added.

Also, in the present invention, it is determined that the user has an intention to move left (right) only when the user moves his/her head left (right) from the center in order to prevent confusion of the user and malfunction of the control device.

Finally, a case that the user views TV using the apparatus for controlling the electrical device according to the present invention will be below described.

First, the user shuts his/her mouth twice in order to activate (ON) the control mode of the apparatus for controlling the electrical device.

In a non-active state (OFF), TV is never affected even though the user shuts his/her mouth or shakes his/her head left and right (for example, conversation or eating, etc.)

If the control mode of a corresponding electrical device is activated, a stripe with ‘left’ on the left side at the bottom of the screen, a channel currently viewed at the center of the screen, and ‘right’ at the right side of the screen, is displayed. Every time when the user moves his/her head left (right) once, the channel is moved to a lower channel or a higher channel. Also, in case of controlling the color of the screen, the user moves his/her head in order to move a current color to a desired color and then shuts his/her mouth in order to specify the color. As such, if the user finishes selecting the color, he/she shuts his/her mouth twice in order to switch the active mode to the non-active mode.

As described above, according to the present invention, a bio-signal depending on a simple movement of the user's face (firm-set mouth and head movement) is employed. Therefore, the present invention has an outstanding advantage that it can control electrical devices through left and right movement and selection between desired command items even by a handicapped person. Further, a simple apparatus for processing the bio-signal is used. Therefore, the present invention has an effect that it can obtain a high performance with a low cost.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. An apparatus for controlling an electrical device using a bio-signal extracted from the movement of a user's face, comprising:
a bio-signal detection means for detecting the bio-signals generated when the user shuts his/her mouth and when the user moves his/her head left and right; and
a means for controlling the electrical device for analyzing the bio-signal detected in the bio-signal detection means to control the electrical device according to a command of the user.

2. An apparatus for controlling an electrical device using a bio-signal extracted from the movement of a user's face, comprising:
a bio-signal detection unit for detecting the bio-signal when the user shuts his/her mouth and when the user moves his/her head left and right;
a bio-signal amplification unit for amplifying the amount of the bio-signal detected in the bio-signal detection unit;
an A/D converter for converting the amplified bio-signal into the bio-signal of a digital mode;
a control unit for analyzing the bio-signal of the digital mode to determine a corresponding command of the user and then generating a predetermined command of the user; and
a transmission unit for transmitting the determined command to the electrical device via infrared signal.

3. The apparatus as claimed in claim 2, wherein if the user shuts his/her mouth twice, the control mode of the electrical device is switched from an inactive (OFF) mode to an active (ON) mode or from the active mode (ON) to the inactive mode (OFF), if the user moves his/her head left (right), left (right) movement is made between command items of the electrical device, and if the user shuts his/her mouth once, the predetermined command item is selected.

4. The apparatus as claimed in claim 2, wherein the left (right) movement between the command items of the electrical device is performed only when the user moves his/her head from the center to the left (right) side.

5. The apparatus as claimed in claim 2, wherein the bio-signal detection unit has a predetermined number of electrodes attached to the user's body portion.

6. The apparatus as claimed in claim 5, wherein the body portion is the forehead of the user.

7. The apparatus as claimed in claim 5, wherein the number of the electrode is two.

8. The apparatus as claimed in claim 7, wherein the two electrodes are positioned under “International 10-20 System of Electrode Placement”.

9. The apparatus as claimed in claim 8, wherein the two electrodes are positioned at Fp1 and Fp2 locations of the forehead of the user.

10. A method for controlling an electrical device using a bio-signal extracted from the movement of a user's face, comprising the steps of:
detecting the bio signals generated when the user shuts his/her mouth and when the user moves his/her head left and right; and
analyzing the bio-signal detected in the bio-signal detection means to control the electrical device according to a command of the user.

11. A method of controlling an electrical device using a bio-signal extracted from the movement of a user's face, comprising the steps of:
detecting the bio-signal when the user shuts his/her mouth and when the user moves his/her head left and right;
amplifying the amount of the detected bio-signal and then converting the amplified bio-signal into the bio-signal of a digital mode;
analyzing the converted bio-signal to determine a corresponding command of the user and then generating the determined command; and
transmitting the generated command to the electrical device via infrared rays.

12. The method as claimed in claim 11, wherein if the user shuts his/her mouth twice, the control mode of the electrical device is switched from an inactive (OFF) mode to an active (ON) mode or from the active mode (ON) to the inactive mode (OFF), if the user moves his/her head left (right), left (right) movement is made between command items of the electrical device, and if the user shuts his/her mouth once, the predetermined command item is selected.

13. The method as claimed in claim 12, wherein the left (right) movement between the command items of the electrical device is performed only when the user moves his/her head from the center to the left (right) side.

14. The method as claimed in claim 11, wherein the step of analyzing further includes an initialization step of obtaining a time period and an average increase/decrease amount of the signal suitable for the user since the moving speed and angle of the head are different depending on users.

15. The method as claimed in claim 11, wherein the step of analyzing further includes an initialization step of setting the reference value and the length of the signal suitable for the user since the time and strength of the users who shut his/her mouth are different.

16. The method as claimed in claim 11, wherein the bio-signal is extracted from a predetermined number of electrodes attached to the user's body portion.

17. The method as claimed in claim 16, wherein the body portion is the forehead of the user.

18. The method as claimed in claim 16, wherein the number of the electrode is two.

19. The method as claimed in claim 18, wherein the two electrodes are positioned under “International 10-20 System of Electrode Placement”.

20. The method as claimed in claim 19, wherein the two electrodes are positioned at Fp1 and Fp2 locations of the forehead of the user.
